(19) United States
(12) Patent Application Publication
(10) Pub. No.: US 2026/0042045 A1
(43) Pub. Date: Feb. 12, 2026

(54) FILTER MODULE, A USE OF A GASKET IN A FILTER, AND A METHOD OF MANUFACTURING A GASKET FOR A FILTER MODULE

(71) Applicant: MANN+HUMMEL Life Sciences & Environment Holding Singapore Pte. Ltd., Singapore (SG)

(72) Inventors: Renjie ZHU, Yancheng City (CN); Huarong CHEN, Suzhou (CN)

(21) Appl. No.: 19/361,708

(22) Filed: Oct. 17, 2025

Related U.S. Application Data
(63) Continuation of application No. PCT/CN2023/090728, filed on Apr. 26, 2023.

(51) Int. Cl. B01D 46/00; B01D 46/52

(52) U.S. Cl. CPC B01D 46/0005; B01D 46/523; B01D 2271/025; B01D 2271/027

(57) ABSTRACT

A filter module includes a filter media, a frame enclosing the filter media so as to define a fluid flow pathway extending between upstream and downstream sides of the filter module, and a gasket arranged between the filter media and the frame to provide a seal tight engagement, wherein the gasket includes a monolithic sheet, and the monolithic sheet is folded in accordion style to form a plurality of pleats with zig-zag folds.

### CROSS-REFERENCE TO RELATED APPLICATION

This application is a continuation application of international application No. PCT/CN2023/090728 having an international filing date of Apr. 26, 2023, and designating the United States, the entire contents of the aforesaid application being incorporated herein by reference.

### TECHNICAL FIELD

The invention relates to a filter module, a use of a gasket in a filter, and a method of manufacturing a gasket for a filter module.

### BACKGROUND ART

HEPA (high-efficiency particulate air) filter, also known as high-efficiency particulate absorbing filter and high-efficiency particulate arrestance filter, is an efficiency standard of air filters. Common standards require that a HEPA air filter must remove—from the air that passes through—at least 99.95% of particles whose diameter is equal to the most penetrating particle size (MPPS), with the filtration efficiency increasing for particle diameters both less than and greater than MPPS.

Dry heat sterilisation and depyrogenisation is considered to be one of the more critical process steps in medicine manufacturing, contributing to ensuring the sterility of pharmaceutical sterile (terminal sterilisation) and aseptic preparations. Inside such sterilisation and depyrogenisation tunnels, HEPA filtration plays an indispensable role in protecting containers, such as vials or prefilled syringes, from contamination that might result in severe health risks for patients. Operating conditions are challenging where the installed HEPA filter has to withstand frequent temperature cycles between ambient and up to 350° C. Traditional high-temperature HEPA filters use inorganic adhesives or elastic glass fiber mats as sealants, which will greatly increase the risk of dust falling and filter leakage during filter use.

There is a need to provide a more efficient and/or more effective filter.

### SUMMARY

According to a first aspect of the present disclosure, there is provided a filter module including:
a filter media;
a frame enclosing the filter media so as to define a fluid flow pathway extending between upstream and downstream sides of the filter module; and
a gasket arranged between the filter media and the frame to provide a seal tight engagement, wherein the gasket includes a monolithic sheet, the monolithic sheet is folded in accordion style to form a plurality of pleats with zig-zag folds.

According to a second aspect of the present disclosure, there is provided a method of manufacturing a gasket for a filter module, wherein the filter module includes a filter media; and a frame enclosing the filter media so as to define a fluid flow pathway extending between upstream and downstream sides of the filter module, and the gasket is arranged between the filter media and the frame to provide a seal tight engagement, the method including:
folding a monolithic sheet in accordion style to form a gasket including a plurality of pleats with zig-zag folds.

According to a third aspect of the present disclosure, there is provided a use of a gasket in a filter module, wherein the filter module includes a filter media; and a frame enclosing the filter media so as to define a fluid flow pathway extending between upstream and downstream sides of the filter module, including:
arranging the gasket between the filter media and the frame to provide a seal tight engagement, wherein the gasket includes a monolithic sheet, the monolithic sheet is folded in accordion style to form a plurality of pleats with zig-zag folds.

### BRIEF DESCRIPTION OF DRAWINGS

Throughout the drawings, it should be noted that like reference numbers are used to depict the same or similar elements, features, and structures. The drawings are not necessarily to scale, emphasis instead generally being placed upon illustrating aspects of the disclosure. In the following description, some aspects of the disclosure are described with reference to the following drawings.

FIG. 1 depicts a block diagram of an example gasket according to various embodiments of the present disclosure.

FIG. 2 depicts a block diagram of an example method of manufacturing a gasket for a filter module according to various embodiments of the present disclosure.

FIG. 3A depicts a block diagram of an example filter module according to various embodiments of the present disclosure.

FIG. 3B and FIG. 3C depict an exploded block diagram of the example filter module as shown in FIG. 3A.

FIG. 4 depicts a block diagram of an example use of a gasket in a filter module according to various embodiments of the present disclosure.

### DETAILED DESCRIPTION

The following detailed description refers to the accompanying drawings that show, by way of illustration, specific details and aspects in which the disclosure may be practiced. One or more aspects are described in sufficient detail to enable those skilled in the art to practice the disclosure. Other aspects may be utilized and structural, logical, and/or electrical changes may be made without departing from the scope of the disclosure. The various aspects of the disclosure are not necessarily mutually exclusive, as some aspects may be combined with one or more other aspects to form new aspects or embodiments. Various aspects are described in connection with methods and various aspects are described in connection with devices. However, it may be understood that aspects described in connection with methods may similarly apply to the devices, and vice versa.

It should be understood that the singular terms “a”, “an”, and “the” include plural references unless context clearly indicates otherwise. Similarly, the word “or” is intended to include “and” unless the context clearly indicates otherwise.

It will be further understood that the terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, a method or device that “comprises,” “has,” “includes” or “contains” one or more steps or elements possesses those one or more steps or elements, but is not limited to possessing only those one or more steps or elements. Likewise, a step of a method or an element of a device that “comprises,” “has,” “includes” or “contains” one or more features possesses those one or more features, but is not limited to possessing only those one or more features. Furthermore, a device or structure that is configured in a certain way is configured in at least that way, but may also be configured in ways that are not listed.

Approximating language, as used herein throughout the specification and claims, may be applied to modify any quantitative representation that could permissibly vary without resulting in a change in the basic function to which it is related. Accordingly, a value modified by a term or terms, such as “about,” “substantially”, is not limited to the precise value specified but within tolerances that are acceptable for operation of the embodiment for an application for which it is intended. In some instances, the approximating language may correspond to the precision of an instrument for measuring the value.

The terms “at least one” and “one or more” may be understood to include a numerical quantity greater than or equal to one (e.g., one, two, three, four, [ . . . ], etc.). The term “a plurality” may be understood to include a numerical quantity greater than or equal to two (e.g., two, three, four, five, [ . . . ], etc.). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of listed elements. As used herein, the phrase of the form of “at least one of A or B” may include A or B or both A and B. Correspondingly, the phrase of the form of “at least one of A or B or C”, or including further listed items, may include any and all combinations of one or more of the associated listed items.

The words “plural” and “multiple” in the description and in the claims expressly refer to a quantity greater than one. Accordingly, any phrases explicitly invoking the aforementioned words (e.g., “a plurality of (objects)”, “multiple (objects)”) referring to a quantity of objects expressly refer to more than one of the objects. The terms “group (of)”, “set (of)”, “collection (of)”, “series (of)”, “sequence (of)”, “grouping (of)”, etc., and the like in the description and in the claims, if any, refer to a quantity equal to or greater than one, i.e. one or more.

The term “first”, “second”, “third” detailed herein are used to distinguish one element from another similar element and may not necessarily denote order or relative importance, unless otherwise stated.

The following examples pertain to various aspects of the present disclosure.

Example 1 is a filter module including: a filter media; a frame enclosing the filter media so as to define a fluid flow pathway extending between upstream and downstream sides of the filter module; and a gasket arranged between the filter media and the frame to provide a seal tight engagement, wherein the gasket includes a monolithic sheet, the monolithic sheet is folded in accordion style to form a plurality of pleats with zig-zag folds.

In Example 2, the subject matter of Example 1 may optionally include a first sealant provided between the filter media and the gasket, and/or between the gasket and the frame, wherein the sealant includes one-component or two-component silicone sealant.

In Example 3, the subject matter of Example 1 or Example 2 may optionally include that an end portion of the monolithic sheet is folded to surround the plurality of pleats with zig-zag folds and wherein the end portion of the monolithic sheet is at least partially sealed to the plurality of pleats of the monolithic sheet by a second sealant.

In Example 4, the subject matter of Example 3 may optionally include that the end portion of the monolithic sheet is sealed to a last pleat of the plurality of pleats of the monolithic sheet by the second sealant.

In Example 5, the subject matter of Example 3 when depending from Example 2 may optionally include that the first sealant includes a same sealant as the second sealant.

In Example 6, the subject matter of Example 3 or Example 5 when depending from Example 2 may optionally include that the first sealant and/or the second sealant include an organic temperature-resistant adhesive.

In Example 7, the subject matter of any of Examples 1 to 6 may optionally include that a thickness of the gasket across the plurality of pleats with zig-zag folds is in a range from about 5 to about 10 mm.

In Example 8, the subject matter of Example 7 may optionally include that the gasket arranged between the filter media and the frame is compressible in thickness to at least about half of its original thickness that the gasket has in an uncompressed state.

In Example 9, the subject matter of any of Examples 1 to 8 may optionally include that the monolithic sheet includes a glass or mineral fiber made of borosilicate glass fiber.

In Example 10, the subject matter of any of Examples 1 to 9 may optionally include that the plurality of pleats of the monolithic sheet are of a uniform size.

In Example 11, the subject matter of any of Examples 1 to 10 may optionally include that the filter media includes a continuous sheet folded in accordion style to form a plurality of pleats with corrugated spacers disposed between consecutive pleats of the continuous sheet.

In Example 12, the subject matter of any of Examples 1 to 11 may optionally include that the frame includes first, second, third and fourth segments enclosing the filter media on four sides thereof, wherein each of the first, second, third and fourth segments includes a reinforcement connection connecting adjacent segments and abutting the adjacent segments, the reinforcement connection being L-shaped, and wherein each of the first, second, third and fourth segments includes at least one stiffener disposed on an outer surface thereof and arranged in a direction parallel to the fluid flow pathway extending between upstream and downstream sides of the filter module.

Example 13 is a method of manufacturing a gasket for a filter module, wherein the filter module includes a filter media; and a frame enclosing the filter media so as to define a fluid flow pathway extending between upstream and downstream sides of the filter module, and the gasket is arranged between the filter media and the frame to provide a seal tight engagement, the method including: folding a monolithic sheet in accordion style to form a gasket comprising a plurality of pleats with zig-zag folds.

In Example 14, the subject matter of Example 13 may optionally include folding an end portion of the monolithic sheet to surround the plurality of pleats with zig-zag folds, and at least partially sealing the end portion of the monolithic sheet to the plurality of pleats of the monolithic sheet by a sealant.

Example 15 is a use of a gasket in a filter module, wherein the filter module includes a filter media; and a frame enclosing the filter media so as to define a fluid flow pathway extending between upstream and downstream sides of the filter module, including: arranging the gasket between the filter media and the frame to provide a seal tight engagement, wherein the gasket includes a monolithic sheet, the monolithic sheet is folded in accordion style to form a plurality of pleats with zig-zag folds.

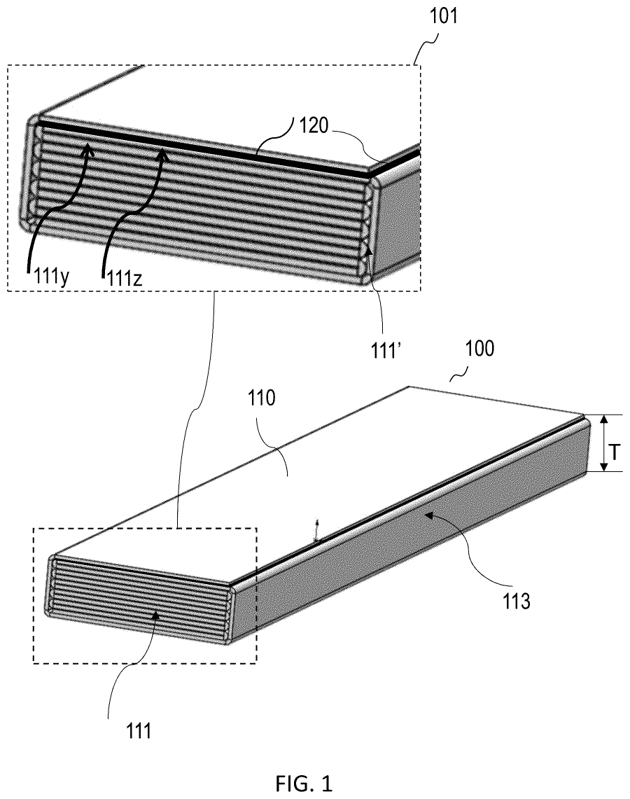

FIG. 1 shows a gasket 100 and an enlarged view 101 of a portion of the gasket 100 according to various embodiments of the present disclosure.

In the context of various embodiments, the term “gasket” refers to an element or component or structure that is configured to seal a gap, junction or space between two other elements or components or structures. The gasket may be made of a material including, but not limited to a shaped sheet or ring of rubber or other material. Specifically, the term “gasket” refers to a flexible or elastic component arranged (e.g. biased) between a filter media and a frame of a filter module to provide a seal tight engagement, wherein the filter module includes the filter media and the frame enclosing the filter media so as to define a fluid flow pathway extending between upstream and downstream sides of the filter module. The fluid may be air. In some embodiments, the fluid may be air in a sterilisation tunnel and/or a depyrogenisation tunnel.

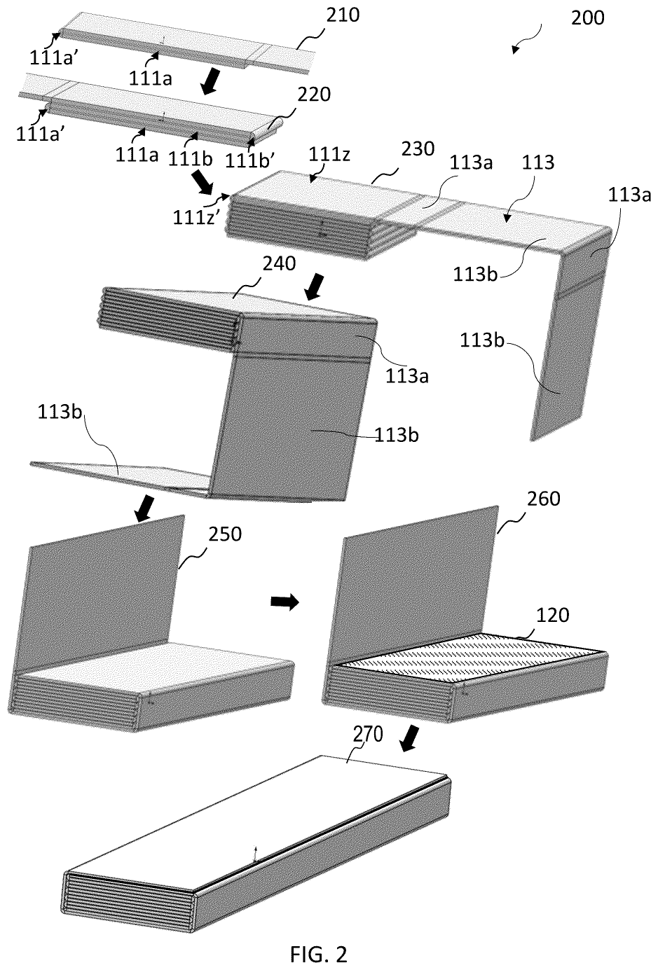

According to various non-limiting embodiments, the gasket 100 may include a monolithic (e.g. unitary, integral) sheet 110. The monolithic sheet 110 may be folded in accordion style to form a plurality of pleats 111 with zig-zag folds 111′. According to various non-limiting embodiments, an end portion 113 of the monolithic sheet 110 may be folded to surround (e.g. wrap, cover) the plurality of pleats 111 with zig-zag folds 111′. The plurality of pleats 111 may be kept in place by the end portion 113. The gasket 100 may therefore have a structured and/or smooth appearance. As shown in FIG. 2, the end portion 113 of the monolithic sheet 100 may comprise a segment 113a that is sized to accommodate a thickness across the plurality of pleats 111, specifically between a first pleat 111a and a last pleat 111z. The end portion 113 of the monolithic sheet 110 may comprise a segment 113b that is sized to accommodate a length of each of the plurality of pleats 111, the length being a length of a pleat in the longitudinal direction of the monolithic sheet 100. The end portion 113 of the monolithic sheet 110 may comprise two segments 113a and two segments 113b, such that the end portion 113 surrounds the plurality of pleats 111.

According to various non-limiting embodiments, the monolithic sheet 110 may include a glass or mineral fiber, for example, made of borosilicate glass fiber. The gasket 100 may be applied in high-temperature high-efficiency filters (e.g. filter modules) that may withstand between about 300° C. and about 400° C. for a long time. The gasket 100 may be made by folding with a standard pleating machine and consequently the size thereof may be controllable, for example, the size of each pleat may be uniform. In other words, the plurality of pleats of the monolithic sheet 110 may be of a uniform size. The present gasket 100 may be produced with high production efficiency to produce a gasket with controllable size, thereby improving effectiveness (e.g. enhancing the practical applications that the gasket 100 may be used in). Because the gasket 100 includes the plurality of pleats 111 folded in an accordion style, the gasket 100 may be biased between a filter media and a frame of a filter module, thereby enhancing the sealing effect and/or improving efficiency (reducing contamination of the downstream filtered fluid due to leakage).

According to various non-limiting embodiments, the end portion 113 of the monolithic sheet 110 may be at least partially sealed to the plurality of pleats 111 of the monolithic sheet 110 by a sealant 120. In some embodiments, the end portion 113 of the monolithic sheet 110 may be sealed to a last pleat 111z of the plurality of pleats 111 of the monolithic sheet 110 by the sealant 120 as shown in the inset 101 of FIG. 1 and in FIG. 2. In some embodiments, segment 113b of the end portion 113 may be sealed to a last pleat 111z of the plurality of pleats 111 by the sealant 120. In some embodiments, the end portion 113 or segment 113b of the monolithic sheet 110 may be sealed to an outer face of the last pleat 111z of the plurality of pleats 111 of the monolithic sheet 110 by the sealant 120, the outer face of the last pleat 111z being one face of the two faces of the last pleat 111z facing the end portion 113 or segment 113b of the monolithic sheet 110 as shown in the inset 101 of FIG. 1 and in FIG. 2. In some embodiments, the end portion 113 may be sealed to a first pleat 111a of the plurality of pleats 111 by the sealant 120. In some embodiments, segment 113b of the end portion 113 may be sealed to a first pleat 111a of the plurality of pleats 111 by the sealant 120. In some embodiments, the end portion 113 or the segment 113b may be sealed to an outer face of the first pleat 111a by the sealant 120, the outer face of the first pleat 111a being one face of the two faces of the first pleat 111a facing the end portion 113 or segment 113b of the monolithic sheet 110. In some embodiments, the end portion 113 may be sealed to the zig-zag folds 111′ by the sealant 120. In some embodiments, segment 113a of the end portion 113 may be sealed to the zig-zag folds 111′ by the sealant 120. In some embodiments, one or two end segments 113a and/or one or two end segments 113b may be at least partially sealed to the plurality of pleats 111 and/or the zig-zag folds 111′ by the sealant 120, to thereby surround the plurality of pleats 111 with the zig-zag folds 111′. In some embodiments, the last pleat 111z may be further sealed to a second last pleat 111y of the plurality of pleats 111 of the monolithic sheet 110 by the sealant 120 (not shown).

According to various non-limiting embodiments, the sealant 120 may include an organic flexible temperature-resistant (e.g. heat-resistant) adhesive. The sealant 120 may have high bonding strength and good sealing performance. Accordingly, there is no limitation on the temperature increase condition for the filter module that includes the gasket 100. The filter module may therefore be capable of withstanding frequent temperature cycles between ambient and about 500° C. or about 450° C. or about 400° C. or about 350° C. The sealant 120 may be a sealant initially in liquid form and hardenable to form an air-impervious solid. The application of the sealant 120 eliminates the risk of dust particles falling off when double-sided adhesive or non-woven sealing gaskets available on the market are used, thereby providing higher production efficiency than other products. The application of the sealant 120 on the end portion 113 to at least partially surround and/or seal the plurality of pleats further enables the gasket 100 to have a controllable size and a structured and/or smooth appearance. Moreover, the application of the sealant 120 avoids the use of double-sided adhesive bonding or non-woven thermal bonding during temperature cycling and consequently avoids the shedding of soot particles caused by high temperature carbonization of such inorganic adhesives or non-woven elastic sealants.

According to various non-limiting embodiments, the sealant 120 may include a one-component or AB two-component liquid sealant (e.g. Silicone glue). The one-component liquid glue, and its main components may be Silicone resins, hydrogen silicone oils and catalysts, etc. The organic heat-resistant glue may be a self-reactive glue containing a catalyst, which may be cured slowly under low temperature, or it may be cured quickly by heating, and it does not require components in the air to participate in the reaction, nor will it release substances into the air. For the AB two-component Silicone glue, glue A may be the main adhesive, and its main components may be silicone resin, hydrogen-containing silicone oil, etc., and glue B may be a curing agent, also known as a catalyst. The glue A and glue B may be mixed according to a certain proportion and stirred evenly. The mixture may be cured slowly at room temperature, or may be cured quickly by heating. The mixture may not require components in the air to participate in the reaction, and may not release substances into the air.

According to various non-limiting embodiments, the monolithic sheet 110 may include a glass or mineral fiber. The glass or mineral fiber may be a borosilicate glass fiber. The gasket 100 including the folded monolithic sheet 110 optimizes the integrity of the seal between a filter media and a frame of a filter module and consequently retains the filter's structural rigidity and filtering efficiency when exposed to high temperatures for relatively long time periods, and particularly when subjected to repeated cycling between low temperature (for example about 25° C.) and high temperature (for example in the range of about 200-500° C.).

According to various non-limiting embodiments, a thickness (denoted as “T” in FIG. 1) of the gasket 100 across the plurality of pleats 111 with zig-zag folds may be provided to fit any gap between the filter media and the frame. In some embodiments, the thickness “T” may be larger than any gap between the filter media and the frame. In an example, the thickness is in a range from about 5 to about 10 mm. When the gasket 100 is arranged between the filter media and the frame, gasket 100 may be compressed within the gap to provide a seal tight engagement. In some embodiments, the gasket 100 may be compressible in thickness to about 90% or about 80% or about 70% or about 60% of its original thickness that the gasket 100 has in an uncompressed state. In an example, the gasket 100 may be compressible in thickness to about 3 to about 7 mm. Because the gasket 100 is compressible, it may be capable of expanding when the frame expands, thereby providing a flexible seal between the filter media and the frame.

FIG. 2 depicts a block diagram of an example method 200 of manufacturing a gasket for a filter module according to various embodiments of the present disclosure. The gasket as shown in FIG. 2 may be the same or similar to the gasket 100 as shown in FIG. 1, and therefore, the common features are labelled with the same reference numerals. Various modifications may be made to the gasket 100 as described herein. Similar modifications as those described with reference to gasket 100 may be made to the gasket as shown in FIG. 2, and vice versa.

At step 210, the monolithic sheet 110 is first folded to include a first pleat 111a with a first zig-zag fold 111a′.

At step 220, the monolithic sheet 110 is further to be folded to include a second pleat 111b with a second zig-zag fold 111b′. The second pleat 111b may be of a same size as the first pleat 111a, for example, the second pleat 111b may be of a same length as the first pleat 111a in a longitudinal direction of the monolithic sheet 110. In other words, the second pleat 111b may overlap with the first pleat 111a, particularly, completely or entirely overlap with the first pleat 111a.

At step 230, the monolithic sheet 110 is continued to be folded to include further multiple pleats until the last pleat 111z with a last zig-zag fold 111z′ and the end portion 113. Accordingly, the monolithic sheet 110 is folded in accordion style to form a plurality of pleats (111a, . . . , 111z) with zig-zag folds (111a′, . . . , 111z′). The zig-zag folds including 111a′, 111b′, . . . 111z′ may include a half-circled shape, a V-shape, a conical shape, or other suitable shapes. In some embodiments, the odd number of zig-zag folds may be of a first same shape and the even number of zig-zag folds may be of a second same shape. The first same shape may be same as the second same shape. The end portion 113 may have a length equal to or greater than a periphery of the plurality of pleats (111a, . . . , 111z) with zig-zag folds (111a′, . . . , 111z′), that is, two times of the length of the plurality of pleats (111a, . . . , 111z), each of which has a same length, plus two times of a thickness of the plurality of pleats (111a, . . . , 111z) with zig-zag folds (111a′, . . . , 111z′), in a manner that the length of the end portion 113 is enough to surround the plurality of pleats (111a, . . . , 111z) with zig-zag folds (111a′, . . . , 111z′). The end portion 113 may include a segment 113a adjacent to the last pleat 111z. The segment 113a may have a length, being a length in the longitudinal direction of the monolithic sheet 100, to accommodate a thickness across the plurality of pleats 111, specifically between a first pleat 111a and a last pleat 111z. A zig-zag fold may connect the segment 113a and the last pleat 111z. The end portion 113 may include a segment 113b adjacent to the segment 113a. The segment 113b may have a length, being a length in the longitudinal direction of the monolithic sheet 100, to accommodate a length of the plurality of pleats 111. A zig-zag fold may connect the segment 113b and the segment 113a. The end portion 113 may include another segment 113a and another segment 113b, so that the length of the end portion 113 may be enough to surround the plurality of pleats (111a, . . . , 111z) with zig-zag folds (111a′, . . . , 111z′).

According to various non-limiting embodiments, the number of pleats may be determined according to a practical requirement. Consequently, the thickness of the gasket may be controllably determined by a product of the number of pleats and a thickness of the monolithic sheet. It should be appreciated that the monolithic sheet 110 may include any number of pleats subject to a practical requirement including even numbers and odd numbers.

At steps 240 and 250, the end portion 113 of the monolithic sheet 110 is folded to surround the plurality of pleats (111a, . . . , 111z) with zig-zag folds (111a′, . . . , 111z′). In some embodiments, when the odd number of zig-zag folds may be of the first same shape and the even number of zig-zag folds may be of the second same shape, a gap between the end portion 113 and the zig-zag folds may be minimum. In other words, the gasket may be in a cuboid shape having two sets of parallel planes and one set of parallel planes perpendicular to the other set of parallel planes.

At step 260, the sealant 120 is applied to a face of the last pleat 111z facing the end portion 113. In some embodiments, the sealant 120 may be applied to a face of the first pleat 111a facing the end portion 113. In some embodiments, the sealant 120 may be applied to zig-zag folds 111′, or specifically a face of zig-zag folds 111′ facing the end portion 113.

At step 270, the end portion 113 (e.g. a first segment 113b of the end portion 113 of similar or same size as the last pleat 111z) is sealed to the last pleat 111z by the sealant 120. Additionally or alternatively, the sealant 120 may be applied to the even number and/or the odd number of zig-zag folds so as to seal the end portion 113 (e.g. segments 113a of the end portion of similar or same size as the zig-zag folds) to the zig-zag folds. Additionally or alternatively, the sealant 120 may be applied to a face of the first pleat 111a facing the end portion 113 so as to seal the end portion 113 (e.g. a fourth segment 113b of the end portion 113 of similar or same size as the first pleat 111a) is sealed to the first pleat 111a. The present method 200 provides the gasket with a structured and/or smooth aesthetic appearance and versatility for use in many practical applications.

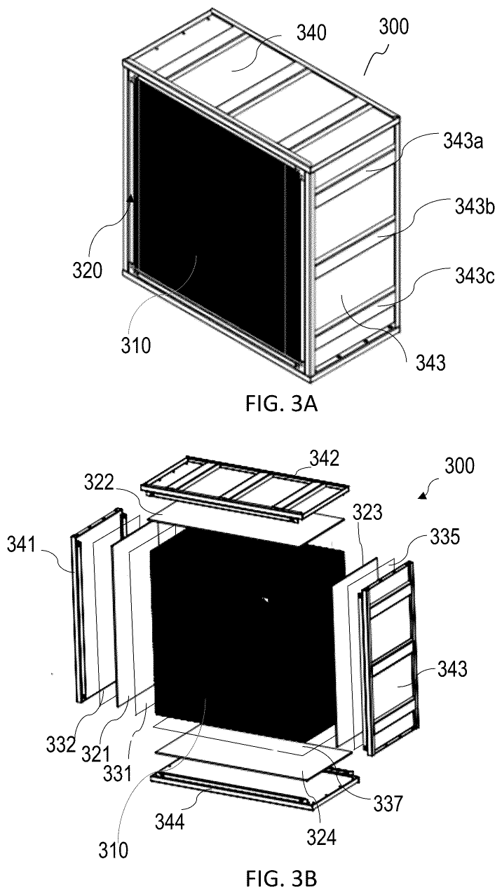

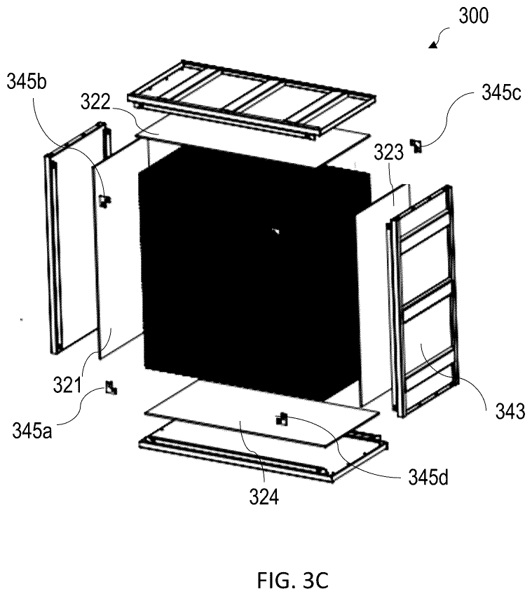

FIG. 3A depicts a block diagram of a filter module 300 according to various embodiments of the present disclosure; and FIGS. 3B and 3C depict an exploded block diagram of the filter module 300 as shown in FIG. 3A.

According to various non-limiting embodiments, the filter module 300 may include a filter media 310; a frame 340 enclosing the filter media 310 so as to define a fluid flow pathway extending between upstream and downstream sides of the filter module 300; and a gasket 320 (including 321, 322, 323, 324) arranged between the filter media 310 and the frame 340 to provide a seal tight engagement. The gasket 320 (including 321, 322, 323, 324) as shown in FIGS. 3A, 3B and 3C may be the same or similar to the gasket 100 as shown in FIG. 1 and/or the gasket 200 shown in FIG. 2. Various modifications may be made to the gaskets 100, 200 as described herein. Similar modifications as those described with reference to gaskets 100, 200 may be made to the gasket 320 (including 321, 322, 323, 324) as shown in FIGS. 3A, 3B and 3C, and vice versa.

In the context of various embodiments, the term “seal tight engagement” refers to a seal tightly formed in between the adjacent components, for example, between the gasket 320 (including 321, 322, 323, 324) and the filter media 310 and between the gasket 320 (including 321, 322, 323, 324) and the frame 340, in a manner that the fluid flowing through the filter media 310 is not allowed entrance or passage through the seal, that is, the seal is impenetrable or impervious to the fluid.

According to various non-limiting embodiments, and referring to FIGS. 3A, 3B and 3C, the gasket 320 (321, 322, 323, 324) may include a monolithic sheet, the monolithic sheet is folded in accordion style to form a plurality of pleats with zig-zag folds, and an end portion of the monolithic sheet is folded to surround the plurality of pleats with zig-zag folds. The filter module 300 including the gasket 320 (321, 322, 323, 324) has advantages of no particle shedding, no cracking of the sealant, high bonding strength, simple production process, and unlimited temperature rise, etc. The present filter module 300 may withstand a temperature of between about 300° C. and about 400° C. for a long time, and meet the requirements of the European standard EN 1822-2009 H13 or higher grade HEPA filter or higher than the ISO 35H grade in the ISO 29463 standard.

According to various non-limiting embodiments, the filter media 310 may include an integral (e.g. unitary or continuous) sheet folded in accordion style to form a plurality of pleats with corrugated spacers (not shown) disposed between consecutive pleats of the continuous sheet. The corrugated spacers may be made of stainless steel or aluminum folded into a wave shape and sandwiched between the filter media of the accordion folded structure, thereby ensuring that the pleats of the filter media will not collapse due to long-term use at high temperature and affect the ventilation channel, e.g. reduce the surface area of the filter media.

According to various non-limiting embodiments, the frame 340 may be a box-type metal (e.g. stainless steel including but not limited to SUS201/304/316/316L) frame. The frame 340 may include first, second, third and fourth segments (341, 342, 343, 344) enclosing the filter media 310 on four sides thereof. Each of the first, second, third and fourth segments (341, 342, 343, 344) may include a reinforcement connection (345a, 345b, 345c, 345d as shown in FIG. 3C) connecting adjacent frame segments and abutting the adjacent segments. As shown in FIG. 3C, the reinforcement connection is L-shaped. The reinforcement connection may be of the same material as the frame 340 to connect the segments (341, 342, 343, 344) of the frame 340, so as to avoid the expansion and displacement of different coefficients at high temperatures, and ensure that the sealant and filter element will not be torn under high temperature conditions.

According to various non-limiting embodiments, each of the first, second, third and fourth segments (341, 342, 343, 344) may include at least one stiffener disposed on an outer surface thereof and arranged in a direction parallel to the fluid flow pathway extending between upstream and downstream sides of the filter module 300. For example, the fourth segment 343 may include three stiffeners 343a, 343b, 343c as shown in FIG. 3A. The stiffener may be of the same material as the frame 340, so as to avoid the expansion and displacement of different coefficients at high temperatures.

According to various non-limiting embodiments, the gasket 320 (321, 322, 323, 324) may be arranged between each side of the four sides of the filter media 310 and each of the fourth segments of the frame 340 to provide a seal tight engagement. A sealant may be provided between the filter media 310 and the gasket 320 (321, 322, 323, 324), and/or between the gasket 320 (321, 322, 323, 324) and the frame 340. The sealant of the filter module 300 may be similar or same to the sealant 120 described with reference to FIG. 1.

For example, the sealant is provided between the filter media 310 and the gasket 320 (321, 322, 323, 324), and between the gasket 320 (321, 322, 323, 324) and the frame 340, as shown in FIG. 3B with respect to the gasket 321 that the sealant 331, 332 are provided. In an example, the sealant is provided between the filter media 310 and the gasket 320 (321, 322, 323, 324), but not provided between the gasket 320 (321, 322, 323, 324) and the frame 340 as shown in FIG. 3B with respect to the gasket 324 that the sealant 337 is provided. In a further example, the sealant is not provided between the filter media 310 and the gasket 320 (321, 322, 323, 324), but is provided between the gasket 320 (321, 322, 323, 324) and the frame 340 as shown in FIG. 3B with respect to the gasket 323 that the sealant 335 is provided. In another example, the sealant is neither provided between the filter media 310 and the gasket 320 (321, 322, 323, 324), nor between the gasket 320 (321, 322, 323, 324) and the frame 340 as shown in FIG. 3B with respect to the gasket 322 that no sealant is provided. Although FIG. 3B shows four possible embodiments in the filter module 300, it should be appreciated that it is preferable to have a same arrangement of sealant with respect to between the filter media 310 and the gasket 320 (321, 322, 323, 324), and with respect to between the gasket 320 (321, 322, 323, 324) and the frame 340. For simplicity, FIG. 3C does not show sealant arrangement in the filter module 300.

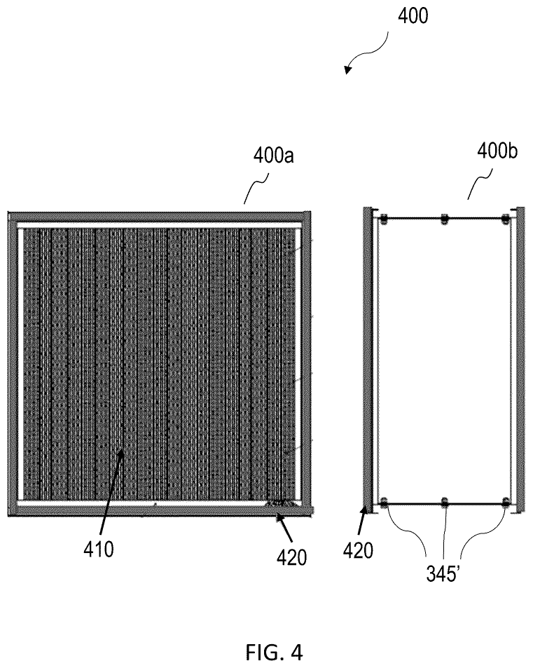

FIG. 4 depicts a block diagram of an example use of a gasket 420 in a filter module 400 according to various embodiments of the present disclosure. A front view of the filter module 400 is shown as 400a and a side view of the filter module 400 is shown as 400b.

According to various non-limiting embodiments, the filter module 400 may include a filter media 410; and a frame enclosing the filter media 410 so as to define a fluid flow pathway extending between upstream and downstream sides of the filter module 400. The use of a gasket 420 in a filter module 400 may include arranging the gasket 420 between the filter media 410 and the frame to provide a seal tight engagement, wherein the gasket 420 may include a monolithic sheet, the monolithic sheet is folded in accordion style to form a plurality of pleats with zig-zag folds. According to various non-limiting embodiments, an end portion of the monolithic sheet is folded to surround the plurality of pleats with zig-zag folds. The gasket 420 as shown in FIG. 4 may be the same or similar to the gasket 100 as shown in FIG. 1 and/or the gasket 200 shown in FIG. 2 and/or the gasket 320 as shown in FIGS. 3A to 3C. Similar modifications as those described with reference to gaskets 100, 200, 320 may be made to the gasket 420, and vice versa.

According to various non-limiting embodiments, the gasket 420 may maintain the filter media 410 in sealed engagement about its entire periphery with the enclosing frame.

According to various non-limiting embodiments, at least one reinforcement connection 345′ is provided to connect adjacent segments of the frame. For example, FIG. 4 shows three reinforcement connections 345′ provided to connect two adjacent segments of the frame.

While this specification contains many details, these should not be understood as limitations on the scope of what may be claimed, but rather as descriptions of features specific to particular examples. Certain features that are described in this specification or shown in the drawings in the context of separate embodiments may also be combined. Conversely, various features that are described or shown in the context of a single embodiment may also be implemented in multiple embodiments separately or in any suitable sub-combination.

That which is claimed is:

1. A filter module comprising:
a filter media;
a frame enclosing the filter media so as to define a fluid flow pathway extending between upstream and downstream sides of the filter module; and
a gasket arranged between the filter media and the frame to provide a seal tight engagement, wherein the gasket comprises a monolithic sheet, the monolithic sheet is folded in accordion style to form a plurality of pleats with zig-zag folds.

2. The filter module according to claim 1, further comprising:
a first sealant provided between the filter media and the gasket, and/or between the gasket and the frame,
wherein the sealant comprises one-component or two-component silicone sealant.

3. The filter module according to claim 2, wherein an end portion of the monolithic sheet is folded to surround the plurality of pleats with zig-zag folds and wherein the end portion of the monolithic sheet is at least partially sealed to the plurality of pleats of the monolithic sheet by a second sealant.

4. The filter module according to claim 3, wherein the end portion of the monolithic sheet is sealed to a last pleat of the plurality of pleats of the monolithic sheet by the second sealant.

5. The filter module according to claim 2, wherein the first sealant comprises a same sealant as the second sealant.

6. The filter module according to claim 3, wherein the first sealant and/or the second sealant comprise an organic temperature-resistant adhesive.

7. The filter module according to claim 1, wherein a thickness of the gasket across the plurality of pleats with zig-zag folds is in a range from about 5 mm to about 10 mm.

8. The filter module according to claim 7, wherein the gasket arranged between the filter media and the frame is compressible in thickness to at least about half of its original thickness that the gasket has in an uncompressed state.

9. The filter module according to claim 1, wherein the monolithic sheet comprises a glass or mineral fiber made of borosilicate glass fiber.

10. The filter module according to claim 1, wherein the plurality of pleats of the monolithic sheet are of a uniform size.

11. The filter module according to claim 1, wherein the filter media comprises a continuous sheet folded in accordion style to form a plurality of pleats with corrugated spacers disposed between consecutive pleats of the continuous sheet.

12. The filter module according to claim 1,
wherein the frame comprises first, second, third and fourth segments enclosing the filter media on four sides thereof,
wherein each of the first, second, third and fourth segments comprises a reinforcement connection connecting adjacent segments and abutting the adjacent segments, the reinforcement connection being L-shaped, and
wherein each of the first, second, third and fourth segments comprises at least one stiffener disposed on an outer surface thereof and arranged in a direction parallel to the fluid flow pathway extending between the upstream and downstream sides of the filter module.

13. A method of manufacturing a gasket for a filter module, wherein the filter module comprises a filter media and a frame enclosing the filter media so as to define a fluid flow pathway extending between upstream and downstream sides of the filter module, and the gasket is arranged between the filter media and the frame to provide a seal tight engagement, the method comprising:
folding a monolithic sheet in accordion style to form a gasket comprising a plurality of pleats with zig-zag folds.

14. The method of claim 13, further comprising folding an end portion of the monolithic sheet to surround the plurality of pleats with zig-zag folds, and at least partially sealing the end portion of the monolithic sheet to the plurality of pleats of the monolithic sheet by a sealant.

15. A use of a gasket in a filter module, wherein the filter module comprises a filter media and a frame enclosing the filter media so as to define a fluid flow pathway extending between upstream and downstream sides of the filter module, comprising: arranging the gasket between the filter media and the frame to provide a seal tight engagement, wherein the gasket comprises a monolithic sheet, the monolithic sheet is folded in accordion style to form a plurality of pleats with zig-zag folds.
